(19) United States
(12) Patent Application Publication
(10) Pub. No.: US 2023/0165237 A1
(43) Pub. Date: Jun. 1, 2023

(54) TRAP AND/OR MONITORING BOX FOR RODENTS AND A METHOD FOR REDUCING A RODENT POPULATION

(71) Applicant: Laguna Holding ApS, Naerum (DK)

(72) Inventor: Axel Julius Haremst, Naerum (DK)

(21) Appl. No.: 17/913,307

(22) PCT Filed: Mar. 23, 2021
(86) PCT No.: PCT/EP2021/057427

§ 371 Date: Sep. 21, 2022

(30) Foreign Application Priority Data
Mar. 25, 2020 (DK) PA 2020 00357
Sep. 17, 2020 (DK) PA 2020 01043

(51) Int. Cl. A01M 23/16

(52) U.S. Cl. CPC A01M 23/16

(57) ABSTRACT

A trap and/or monitoring box and method of use to suppress a rodent population are provided. The trap and/or monitoring box includes enhanced incentive for use by rodents also being safe for use in a public environment. The trap and/or monitoring box includes a housing forming a cavity at least the size of a body length of a targeted rodent, a cover, and a bottom surface including an access opening allowing a rodent to access the surface from ground level. A trapping device is positioned inside the cavity and/or a camera is positioned inside or outside of the cavity at a position to register rodent activity inside or in and out of the cavity, and/or other means for registration such as a sensor are positioned inside or outside of the cavity at a position to register activity inside or in and out of the cavity.

### TECHNICAL FIELD OF THE INVENTION

The invention disclosed herein relates to a trap and/or monitoring box and to a method for using this trap and/or monitoring box to suppress a rodent population. More particularly, the present invention relates to a trap and/or monitoring box for rodents having enhanced incentive for use by rodents while the trap box is also safe to use in a public environment.

### BACKGROUND

Rodents are persistent pests, presenting a continual threat to health and goods wherever humans' dwell or carry out business. Rodents continue to be a source of disease and economic damage through spoilage of food and non-food items alike. Although ancient scourges such as bubonic plague are rare, rodents are linked to such diseases as spirochetal and tick-borne diseases and hantavirus disease. The presence of these animals at homes, offices, and industrial plants is undesirable.

Rodents are often controlled through poison or traps. Poison and traps are normally placed within specialized containers, called bait stations, to prevent children, non-targeted animals, and unauthorized individuals from getting into contact with the poison or the trap. Bait stations are designed to isolate the poison or trap from ready access to all but targeted rodents. A typical bait station comprises a plastic box or a metal box within which a trap or poison bait is placed. Typically, bait stations are relatively small units placed along walls and other places where rodents are likely to frequent. To prevent animals or children from gaining access to the contents of the bait stations by tipping or shaking, a bait station is often screwed or nailed to the floor or other structure. To maintain the effectiveness of the bait station, the poison bait must be replaced periodically and traps within the bait station must be emptied for dead rodents and reset.

Currently, multiple rodent trapping devices are available in the market. However, the conventional rodent trapping devices are complex in design, unsafe, single use, and hideous.

WO 01/91550 (ATLANTIC PASTE & GLUE CO. INC.) discloses a pest control article, which includes a pest control device such as a poisoned bait trap and a decorative housing. The housing includes a decorative unit and pedestal supporting the decorative unit. A compartment within the pedestal is provisioned with the poisoned bait allowing the pest control device to be out of public view. Rodents or insects enter the compartment through one or more apertures within the pedestal so as to access a trap or poisoned bait.

CN207733515 (YE BINGCHENG), discloses a kind of remotely intelligently monitoring mousetraps with corner mirror, have angle shape channel box, and the corner on the inside of the box of channel is equipped with plane corner mirror, and mouse sticking plate is housed on its inner wall. Corner on the inside of the box of channel is equipped with IP Camera, and IP Camera communication connects the hotspot or wireless router mating with it. However, above-mentioned prior arts fail to provide an efficient and automatic trapping device activated by means of a camera.

EP3289871 (CAMRO APS) disclose a child and pet secure rodent poison free trap. This trap comprises a housing with a rat and/or mouse entry opening positioned in a side wall or bottom wall. A mechanical or electrical killing device is positioned within the housing and the killing means is positioned at a level above the level of the entry opening. The killing means is positioned in such a way that the rat or mouse reaches the killing means by standing within the housing on ground level on their hindlegs, i.e. the rodent never access the level above the level of entry where the trap is positioned. The trap therefore does not provide a raised and dry, hiding or potential residence place for a rodent.

According to prior art, the success rate of rodent control in an area is defined by the number of killed rodents in the area, however, the success rate of rodent control may more suitably be defined by monitoring rodent activity in an area, as the number of killed rodents may illustrate the effectiveness of present traps or composition of a rodent population instead of general rodent activity. Also, that a large number of rodents is killed in traps in a monitored area may indicate that there is a huge population of rodents in the area, however, a small number of rodents killed in traps does not exclude that a population of breeding rodents exists in the area, or whether a smaller population is increasing or decreasing.

A box according to the present invention allows monitoring of rodents such as rats without interfering with the rodents lives and use of a box according to the invention may contribute to a significantly improved model of rodent activity in a monitored area, and in particular the box may contribute to modelling whether rodent activity is either low or whether the rodent appearances are the result of a population composition e.g. a population dominated by older and more experienced rodents.

In the light of above-mentioned problems, there is a need to provide a trap and/or monitoring box for rodents used for monitoring activity of rodents such as mice and rats without use of necessarily killing the individual animal, but instead changing the conditions in the monitored area and thereby suppressing rodent populations in a controlled fashion. Further, there is also a need for a rodent trap and/or monitoring box which may be easily and inexpensively manufactured, safe, hygienic, and without exposing a trap or a trapped rodent to the environment.

### SUMMARY OF THE INVENTION

The present invention discloses an environmentally friendly trap and/or monitoring box and use of such a trap/monitoring box. More specifically, the present invention relates to a rodent trap and/or monitoring box which both increases the rodent's incentive to visit the box, and which is safe to use to catch rodents, i.e., it is difficult for children and pets to come into contact with a trap.

According to a first aspect, the invention relates to a rodent trap and/or monitoring box (100) used for trapping and/or monitoring rodents, the box (100) comprises:
a housing comprising one or more walls (108, 110, 104, 106) extending upwards to form a cavity (105), the cavity (105) is limited upward by a cover (118) and is limited at least partly downwards by a surface (112), either walls (108, 110, 104, 106) or surface comprise an access opening (103, 116) or an access edge (103a) allowing a rodent to access the surface (112) from ground level,
a trapping device (114) is positioned inside the cavity, and/or a camera (122) is positioned inside or outside of the cavity at a position where it is possible to register activity inside the cavity, or in and out of the cavity, and/or other means for registration such as a sensor may be positioned inside or outside of the cavity at a position where it is possible to register activity inside or in and out of the cavity, wherein the cavity (105), or the surface (112) of the cavity, is large enough to allow a rodent to position itself/take up residence/stay/rest on the downward limiting surface, i.e. the floor or bottom surface of the cavity (105) is at least the size of a body length of the targeted rodent in at least one horizontal dimension.

The walls extend upwards to such an extent that a space or room is created between the surface, i.e. the floor or bottom surface of the cavity (105), and the upward cover. The walls may extend substantially vertically as such walls create a cavity with a uniform height making it easy to arrange e.g. trap and/or camera and/or other sensor or registration devices inside the cavity, together with transmitters providing a real time feedback in rodent activities inside and around the box(es).

The minimum size of the surface, i.e. the floor or bottom surface of the cavity (105), allows a rodent to take up residence on the surface inside the cavity. The cavity is therefore considered as a potential nesting place by the rodent, and this will attract a different kind of rodents compared to rodents attracted to a traditional trapping mechanism which only attracts rodents by offering food. The traditional trapping mechanism offering food may attract all kind of rodents, but it will primarily kill young inexperienced rodents, older experienced rodents may recognize the trapping mechanism and at least a part of the older rodents will not get killed.

The closed housing comprising walls and a top protect the optional trapping mechanism and the rodents from public attention, also a camera or other sensitive equipment may be mounted inside the cavity and may thereby also be protected from weather and vandalism. The trap and/or monitoring box according to the invention may also comprise a locking mechanism making it impossible for the public—especially for children—to open or break into the box, also, the large size of the cavity makes it possible to position a trapping mechanism at a significant distance from the entrance opening(s) thereby making it impossible to reach the trapping mechanism by hands and fingers inserted through a rodent entrance.

The trap and/or monitoring box provides an inexpensive, compact, and efficient means for monitoring rodent activity, and based on the monitored and registered activity, the owner or user of the locality may either do nothing and trust that the rodent activity is low or not existing, or the owner or user of the locality may take initiatives to reduce rodent activity based on recommendation if rodent activity is too high or increasing.

According to any embodiment of the rodent trap and or monitoring box, the surface, i.e. the floor or bottom surface of the cavity (105), may comprise or be constituted of a platform (112) raised above ground level to allow rodents to pass below the platform (112), the area of the platform (112) may be large enough in a horizontal dimension for a targeted rodent such as a rat to position itself/take up residence/stay/rest on the platform. The one or more platform(s) may be placed at either the same height/raised level or at different heights/raised levels. According to any embodiment of the rodent trap and or monitoring box comprising a platform, the platform (112) may be positioned at least 2 cm above ground level, or e.g. at least 5 cm above ground level, or e.g. at least 7 cm above ground level, or e.g. at least 10 cm above ground level where the exact height at which the platform is positioned may be defined by the targeted rodent.

According to any embodiment of the rodent trap and or monitoring box comprising a platform, the platform (112) may be configured to attract rodents by comprising or be constituted of materials and surface structures appealing to a targeted rodent. According to any embodiment of the rodent trap and or monitoring box, the surface or a platform (112) may be made of a natural material such as wood or a wood product such as plywood.

According to any embodiment of the rodent trap and or monitoring box, the housing may be at least partly or completely without a bottom-structure, i.e. if the housing comprises a platform this allows rodents to pass below a platform (112) on ground surface, which ground surface may comprise grass, soil, tiles, asphalt, pavement or the like, and if the housing does not comprise a platform (112) this allows rodents to enter the housing via the ground surface on which the housing is placed. The housing may be supported by the upward extending walls (108, 110, 104, 106) or the housing may be supported by e.g. legs or wheels extending below the walls or below the platform.

According to any embodiment of the rodent trap and or monitoring box, the inner cavity (105) at a horizontal dimension may comprise or be configured with:
a minimum cross-section of at least 15 cm, e.g. at least 15×25 cm for a rectangular inner cavity (105) and e.g. at least 15 cm in diameter for a round inner cavity (105), and/or the area of the cross-section is at least 175 cm²,
or may have a minimum cross-section of at least 20 cm. e.g. at least 20×25 cm for a rectangular inner cavity (105) and e.g. at least 20 cm in diameter for a round inner cavity (105) and/or the area of the cross-section is at least 314 cm²,
or may have a minimum cross-section of at least 25 cm. e.g. at least 25×25 cm for a rectangular inner cavity (105) and e.g. at least 25 cm in diameter for a round inner cavity (105) and/or the area of the cross-section at least 490 cm².

According to any embodiment of the rodent trap and or monitoring box, the upward cover (118) defining the upper surface of the inner cavity (105) is positioned at least 10 cm above ground level or above a platform (112), or the upward cover (118) is positioned at least 15 cm above ground level or above a platform (112), or the upward cover (118) is positioned at least at least 20 cm above ground level or above a platform (112), or the upward cover (118) is positioned at least at least 25 cm above ground level or above a platform (112). According to any embodiment of the rodent trap and or monitoring box, the rodent trap and/or monitoring box (100) may comprise functional features at a top level e.g. above the upward cover (118) or as part of the upward cover, where the box (100) may be configured to hold and fix one or more plant boxes or containers, or the box (100) may be configured with a closed storage compartment, or the box (100) may be configured as a garbage bin or an ash tray.

According to any embodiment of the rodent trap and or monitoring box, the box (100) my comprise a side or top user access opening (115) which in combination with a user access opening cover may be configured to allow opening and closing for user access during use, i.e. the user access opening cover, e.g. constituted by the top cover (118) or one wall (108, 110, 104, 106) or a part of the cover (118) or a part of the wall (108, 110, 104, 106), has an open and a closed position.

According to any embodiment of the rodent trap and or monitoring box, the box may comprise a user access opening (115) and a cover (106) covering the user access opening (115) when closed, which cover (116) may be fixed to the platform (112) in such a way that the platform (112) is pulled out of the cavity (105) when the cover (106) is removed by pulling it away in a horizontal direction, also, the platform (112) may comprise contact parts configured to slide e.g. horizontally along guiding rails mounted inside the cavity (105) like a drawer when opened and closed.

According to any embodiment of the rodent trap and or monitoring box, the box may comprise a user access top opening (115) and a top cover (118) protecting the access top opening (115) when closed, the top cover (118) may be connected to the housing by a hinge and the top cover (118) may therefore be configured to be opened by pivoting the top cover (118) relative to a stationary part of the housing where the hinge is attached.

According to any embodiment of the rodent trap and or monitoring box, the housing may comprise a plurality of entrances (116) at ground level, which entrances (116) may be positioned in such a way relative to each other that the plurality of entrances allows a rodent to see a path or opening through the inner cavity or below the inner cavity at ground level.

According to any embodiment of the rodent trap and or monitoring box, the box may comprise a trapping device (114) positioned on ground level or on a platform (112) if present, the trapping device may be a mechanical trap or an automatic or electrical trap, alternatively, a poison or a trace element allowing tracing a rodent outside the box.

According to any embodiment of the rodent trap and or monitoring box, the distance d between an entrance opening (116) and a trapping device (114) positioned at ground level, or the distance d between at least one access edge (103, 103a) of a platform (112) and a trapping device (114) positioned on the platform is at least a body length of a targeted rodent which, depending on the rodent to be targeted, may be at least 5 cm, or at least 10 cm, or at least 15 cm, or at least 20 cm.

According to a second aspect, the invention relates to a method for monitoring rodent activity in a monitored area, which method comprises the following steps:

I) Reviewing of a monitored area which may include both open land and buildings to identify parts or positions where rodent activity are most likely, and e.g. identify problems such as accessible drains or sewers, or openings where rodents may access buildings,

II) Identifying suitable positions within the monitored area for one or more boxes according to the first aspect, based on knowledge obtained during step I), e.g. near planting, garbage cans, house walls, etc., and setting up boxes at the chosen positions, step I) may be optional as the owner/user of the monitored area may define positions where to set op the boxes,

III) Receiving data from each box set up in the monitored area, data may include number of rodents appearances inside the cavity and e.g. whether it is one rodent appearing several times or several rodents appearing each one time, number of rodents appearances below a platform, number of rodents killed in traps inside the box, etc.,

IV) Estimating size of the rodent population for a period e.g. weekly or monthly, optionally estimating origin or composition of the population, and e.g. whether the population is increasing or decreasing,

V) Based on the population estimation of step IV), recommendations are made to the owner/user of the monitored area whether any measures need to be taken to change conditions for the population, and what specific measures need to be taken.

According to any embodiment of the method according to the second aspect, at least a part of the data registered in step III) are registered electronically and send to a platform in real time allowing a user to act immediately upon receiving data in respect of a rodent observation.

According to any embodiment of the method according to the second aspect, the population estimation obtained in step V) may be used for documentation e.g. toward pest control authorities, management or other parties.

According to any embodiment of the method according to the second aspect, between 1-30 boxes may be used to monitor a monitored area, or minimum 1, 2 or 3 boxes may be used to monitor a monitored area, or maximum 10, 20 or 30 boxes may be used to monitor a monitored area. If more than the maximum number of boxes are used, the monitored area may preferably be divided into two or more monitored areas.

According to an alternative aspect, the present invention relates to a rodent trap and/or monitoring box (100) used for trapping and/or monitoring rodents which box (100) is supported by a ground level surface when in operation, and comprises:
a housing comprising one or more walls (108, 110, 104, 106) extending substantially vertically to form a cavity (105), the cavity (105) is limited upward by a cover (118),
a trapping device (114) positioned inside the cavity (105) and/or a camera (122) and/or other means for registration affixed inside the housing to monitor rodent activity inside the cavity (105), or to/from the cavity (105),
one or more entrance openings (116) to the housing giving access to the inner cavity (105) positioned at ground level, which entrance opening(s) (116) is/are open downwards i.e. the surface which is touched by a rodent entering the rodent trap box (100) is the surface of the ground level surface and the surface is the same outside the entrance (116) as inside of the entrance (116),

which inner cavity (105) has a minimum cross-section of at least 15 cm, e.g. at least 15×25 cm for a rectangular inner cavity (105) and e.g. at least 15 cm in diameter for a round inner cavity (105), and the area of the cross-section is at least 175 cm²,

or has a minimum cross-section of at least 20 cm. e.g. at least 20×25 cm for a rectangular inner cavity (105) and e.g. at least 20 cm in diameter for a round inner cavity (105) and the area of the cross-section is at least 314 cm²,

or has a minimum cross-section of at least 25 cm. e.g. at least 25×25 cm for a rectangular inner cavity (105) and e.g. at least 25 cm in diameter for a round inner cavity (105) and the area of the cross-section at least 490 cm².

According to yet an alternative aspect, the present invention relates to rodent trap box (100) used for trapping and/or monitoring rodents which rodent trap box (100) is supported by a ground level surface when in operation, and comprises:
a raised base (102) comprising one or more walls (108, 110, 104, 106) extended upwardly from a perimeter of the raised base (102) to form a cavity (105) with an upward opening,
at least one platform (112) securely positioned at the level of the raised base (102) within the cavity (105), which platform (112) is configured to attract rodents,
a trapping device (114) positioned on the platform (112) and/or a camera (122) securely affixed to monitor rodent activity on the platform (112) or to/from the platform (112) or below the raised base (102),
one or more entrances (116) positioned at the ground level beyond the raised base (102), which entrance(s) (116) is/are open downwards i.e. the surface which is touched by a rodent entering the rodent trap box (1009 is the surface of the ground level surface and the surface is the same outside the entrance (116) as inside of the entrance (116).

### BRIEF DESCRIPTION OF THE DRAWINGS

For illustrating the invention, exemplary embodiments of the invention are shown in the drawings. However, the invention is not limited to the structures disclosed in the drawings. The description of a structure referenced by a numeral in a drawing is applicable to the description of that structure shown by that same numeral in any subsequent drawing herein.

FIG. 1 illustrates a top perspective view of a first embodiment of a rodent trap and monitoring box provided with both a trap and a camera according to the present invention.

FIG. 2 illustrates a perspective view of the first embodiment of rodent trap and monitoring box provided with a platform for deposit food to attract the rodents according to the present invention.

FIG. 3 illustrates a side perspective view of the rodent trap box provided with one or more holes/entrances for rodents to enter and direct towards the platform and the automatic trapping device according to the present invention

FIG. 4A-4D illustrates a second embodiment of a rodent trap and/or monitoring box according to the present invention.

FIG. 5 illustrates a third embodiment of a rodent trap and/or monitoring box according to the invention.

FIG. 6 illustrates a fourth embodiment of a rodent trap and/or monitoring box according to the invention.

FIGS. 7 and 8 illustrates a fifth embodiment of a rodent trap and/or monitoring box according to the invention.

FIG. 9A-9D illustrates a sixth embodiment of a rodent trap and/or monitoring box according to the invention.

### DETAILED DESCRIPTION OF THE INVENTION

The trap and/or monitoring box 100 according to the invention has a large inner compartment or cavity 105 compared to known trapping or monitoring constructions.

The large inner cavity appeals to rodents for hiding and nesting and incite rodents to explore the compartment. In general, a rodent trap and/or monitoring box 100 according to the invention is resting on a ground level surface, which ground level surface may be constituted of a material such as concrete, asphalt, pavement, soil, sand, gras or similar. Normally, a rodent trap and/or monitoring box 100 according to the invention is not constituted with a bottom at ground level, therefore a rodent may pass under or into the housing of the rodent trap and/or monitoring box 100 without experiencing a change in ground level surface, at least if the rodent travel at a certain path.

Normally, the rodent trap and/or monitoring box 100 comprises a housing constituted of one or more walls which are extending upward, and which may be extending substantially vertically to form a cavity 105. The cavity 105 may have an upward opening or top opening which opening is provided with a lid or cover 118, e.g. the cover may be part of a plant box or a garbage bin or ash tray or a storage room positioned above or on top of the cavity 105.

That the walls are “substantially” vertical means that wall(s) may be straight or curved or inclined but to some extend the walls extend in a vertical direction and form the inner cavity 105. Shape or inclination of the walls is not significant for the invention. The walls, and therefore the cavity 105, may have any cross-sectional form, e.g. circular or oval or polygonal such as rectangular or square.

In general, the walls of the housing may be constituted of any material e.g. a polymer such as PE e.g. HDPE, PVC, PP, PC, ABS or PLA, or wood e.g. hardwood such as oak, maple, or walnut, or softwood such as pine, spruce, beech or the like, or metal e.g. steel, iron, zinc, aluminum or the like. The housing may also have a decorative purpose in public space where e.g. the top or cover may comprise or be constituted of a plant box and/or the side walls may be covered with advertisements or messages.

A rodent trap and/or monitoring box 100 according to the invention may comprise a platform 112 inside the cavity 105 or forming the bottom of the cavity 105. The platform 112 is raised so much from the ground that a rodent such as a rat or a mouse, will have to choose whether to jump onto the platform or to pass below the platform. The platform 112 may be raised at least 2 cm above ground level, e.g. at least 3 or at least 4 or at least 5 cm or at least 7 cm or at least 10 cm above ground level. The position above ground level of the platform 112 may depend on which rodent in particular the box 100 is desired to target. The platform 112 may comprise an access opening 103 or at least an access edge or open side 103a facing an opening to ground level which access opening 103 or edge 103a gives a rodent access to the platform 112 from ground level. In general, the distance from the edge of the access opening 103 or the access edge 103a, to a wall of the housing, or to a trap positioned on the platform, at least at one position or along one edge, should be at least a body length of the type of rodent which the box 100 is determined to target. This distance d will allow the rodent to enter onto the platform 112 without meeting any obstacles and even the most cautious and timid rodents will dare to explore a horizontally open space.

A box 100 according to the invention is relatively large compared to ordinary rodent traps seen in the public area. A box 100 according to the invention will normally be large enough to have a function in the public room e.g. the box 100 may support one or more detachable plant boxes or containers, or the box 100 may comprise an upper compartment i.e. a compartment above the platform 112 which may be used to store e.g. tools for maintaining parks or roads, alternatively the rodent trap box 100 may support a bench surface or a sculpture or another feature having a functional purpose—practical or ornamental—in the public environment. The box 100 may comprise a top part having a functionality not related to trapping or housing rodents, or alternatively, the box 100 may comprise a top part providing the impression that it has another functionality and it may therefore not be perceived as a rodent trap or a rodent monitoring device.

In general, in respect of size, the inner cavity 105 of the box 100 may be at least 20 cm high, i.e. the inner cavity 105 extends 20 cm from ground level to a top surface of the inner cavity 105, or the inner cavity 105 is at least 30 cm high, or at least 40 cm high.

In general, a platform 112 may be placed inside the inner cavity 105 or constitute the bottom of the inner cavity 105 at a level above ground level and at a level below the top surface of the inner cavity 105, preferably the platform 112 is positioned at a raised level.

In general, the housing of the rodent trap and/or monitoring box 100 may comprise legs or wheels extending below the inner cavity 105 or below a platform 112, which legs or wheels or similar may support the walls of the housing at ground level. Alternatively, the walls of the housing may rest directly on the ground level.

A platform 112 may be fixed to the walls of the housing and carried by the housing, or the platform 112 may be movably mounted relative to the housing e.g. on elongated posts or walls or wheels allowing the platform 112 to be moved relative to the housing or stationary walls of the box 100 e.g. sideward by sliding or wheeling the platform 112 out of the housing or upward by lifting the platform 112 up.

The platform 112, i.e. the upper surface of the platform 112, should be large enough to allow a rodent to reside or stay on the platform 112, i.e. between the edge of the platform 112 constituting an entrance opening 103, 103a and either a wall e.g. forming part of the cavity 105 or a trap mechanism 114, the distance d should be at least the body length of the rodent, preferably longer. Such a minimum distance drain allows the rodent to enter upon the platform 112 and examine the space.

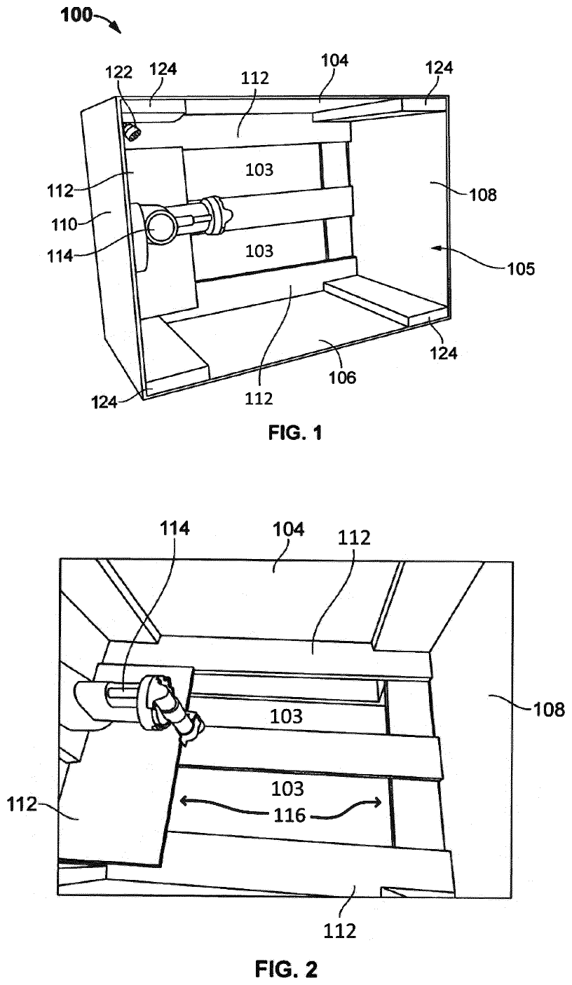

FIG. 1 discloses a first embodiment of a rodent trap and monitoring box 100 according to the invention, FIG. 1 shows a view where the top cover of the box is removed, and the viewer looks down into the cavity of the box or housing. This embodiment of the box 100 is configured to support one or more detachable plant boxes/containers which constitutes a top cover for the inner cavity 105 during operation. The box 100 comprises a plurality of connected platforms 112 positioned at a raised level and access openings 103 allowing rodents to enter up onto the platform 112 during operation. The first embodiment of the box 100 shown in FIG. 1 is rectangular comprising a front wall 108, a rear wall 110 and two side walls 104, 106. The front wall 108, the rear wall 110, and the sidewalls 104, 106 are securely connected together using one or more supports 124 and fasteners.

The platforms 112 are securely affixed to or positioned or formed at the raised level within the box 100 at the bottom or lower end of the cavity 105. The platforms 112 are configured to allow a user to deposit food as a means of attracting and capturing rodents, such as rats or mice. The relatively large platforms 112 are also configured to allow the user to deposit nesting material to attract rodents seeking a place to have their young. The platforms 112 may be made of a natural material such as wood or a wood product such as plywood. Rodents especially rats finds natural materials appealing and are more likely to enter a surface made of a natural material, however, the material should also have a relatively smooth surface as it might be necessary to clean the surface to remove food remains and/or dead rodents.

In general, a rodent trap box 100 may comprise a user access opening 115 allowing a user to access the cavity 105 or a platform 112 of the box 100. The user access opening 115 may extend over the complete top as shown in the first embodiment, or the user access opening 115 may be a partial opening in a side wall of the housing or extend over a complete side wall of the housing. Alternatively, the housing being constituted of walls and a top cover may stand directly on the ground (i.e. the housing has no bottom or only a partial bottom) and the housing may then be lifted or pivoted around a lower side of a wall to provide an access opening 115 to the inner cavity.

In general, the user access opening 115 may be closed by a cover during operation which cover can prevent unauthorized access to the inner cavity of the housing or box. The cover may be provided with a locking mechanism e.g. a locking mechanism which is to be opened by a key or a code which is only available to authorized personnel.

A user access opening 115 may comprise a side opening, which side access opening 115 may be closed by a cover or a door attached to a wall of the housing of the box 100 by a hinge, or the side access opening 115 may be closed by a cover being opened and closed by sliding a part, e.g. a platform, horizontally along guiding rails mounted inside the cavity 105 like a drawer. Also, the user access opening 115 may be a top opening which opening may be protected or closed by a top cover 118. A top cover 118 may be connected to a side wall of the housing of the box 100 by a hinge, consequently the top cover may be opened providing access to the cavity 105 by pivoting the top cover relative to the side wall where the hinge is attached, alternatively, a top cover may be constituted of a plate or a lid which may be lifted off when the user wants access to the inner cavity.

An automatic trapping device 114 may be securely affixed to a wall or to the platform 112 within the cavity 105 of the box 100 using one or more fasteners such as screws, nuts, or bolts. The automatic trapping device 114 may be configured to effectively trap or kill rodents including rats and mice. The presence of a trap is optional, but many users prefer to have rodents killed instead of solely having the rodent population monitored. However, the number of killed rodents adds information to the monitoring of the population, and the addition of a trapping device may therefore give a more complete picture of the rodent population.

The box 100 may comprise a camera 122. The camera 122 is positioned in such a way that it may monitor rodent activity e.g. below the platform 112 or e.g. to and/or from the platform 112 or e.g. on a platform 112. The presence of a camera is optional, the box or the platform may instead comprise sensors such as weight sensors which indicate when a rodent enters into the cavity or up onto a platform. However, a camera is a preferred indicator for rodent presence in the box as the camera will allow the user to see how the rodent behaves inside the box. A camera alone, or a camera in combination with a sensor such as a weight sensor, may be used for identification of rodents entering into the box.

In general, one or more detachable plant boxes/containers may be securely positioned on a top portion of the box 100, e.g. plant boxes/containers may be positioned partly lowered into an upward opening of the cavity 105 of the box 100.

FIG. 2 discloses the inside of the first embodiment of the box 100 from a different angle than FIG. 1 as FIG. 2 discloses the platform 112 inside the cavity 105 of the box 100 and a rail 117 supporting the housing of the box 100 at ground level. In an exemplary embodiment, the platform 112 is securely positioned to a wall at a raised level within the cavity 105 of the box 100. The platform 112 may be designed as feeding platform or it may be designed as appealing to a rodent for nest-building and hiding. A purpose directed design is obtained by choosing materials and shapes e.g. hides or openings which appeal to e.g. a particular rodent for a particular purpose.

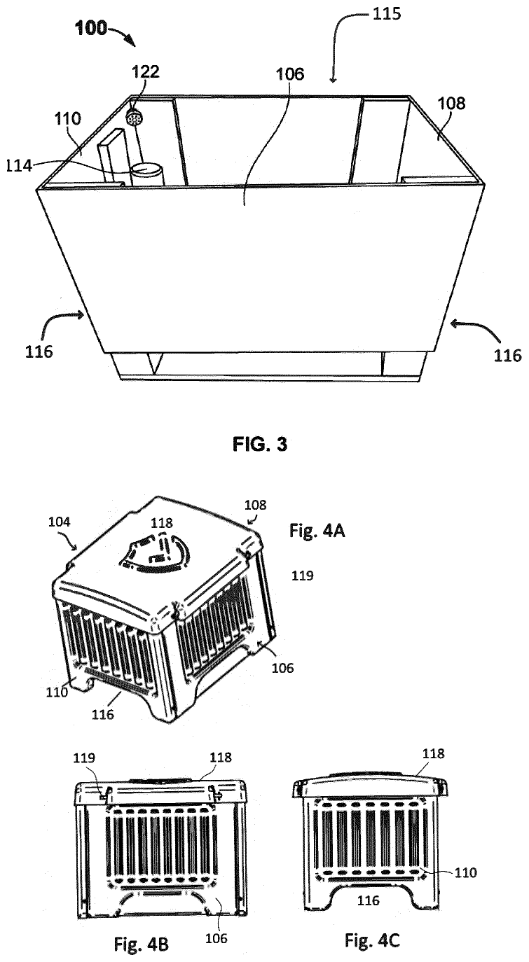

FIG. 3 discloses a side view of the first embodiment of the box 100, and this view illustrates the position of an entrance opening or a hole 116 in a wall of the box 100. The entrance opening or hole 116 is positioned at ground level below the platform 112 at the front wall 108 and at the rear wall 110, normally an entrance opening 116 is open downwards and a rodent may enter into the box 100 while walking directly on the ground surface, i.e. the rodent will not experience a change in the surface when entering into the box 100, the rodent will instead experience an opportunity to hide as it enters below the platform 112.

The box 100 may comprise one or more entrances 116 at any one side or at all sides of the box 100. The entrance opening or hole 116 may be disposed along at least any one side or other sides of the box 100 for the rodents to enter at ground level. When a rodent has entered the box 100 and is hiding under the platform 112, the rodent will experience an opportunity to enter the platform 112 where the rodent may get into contact with the automatic trapping device 114 (shown in FIG. 1) or may be registered by a camera 122 or a different counting or registration mechanism.

The opportunity to enter a platform 112 may comprise a downward access opening 103 in the platform 112, and such an access opening 103 may have any shape or edge. E.g. the platform 112 is constituted of a frame work with many access openings 103, or the platform 112 is e.g. constituted of planks or boards positioned with a distance between them which distance forms an access opening 103, or the platform 112 may be constituted of a board provided with cut openings or the like. In the first embodiment of FIG. 1, the platform 112 is constituted of 3 boards placed with distance between neighboring boards together with plate mounted at one end of the box 100, the distance between two boards constitute a downward access opening 103 according to this embodiment.

According to one embodiment, a camera 122 may be securely affixed inside the cavity 105 of the box 100. The camera 122 may be affixed to the inner surface of a wall of the box 100, e.g. at such a level that it is possible for the camera 122 to monitor rodents accessing the platform 112, or alternatively at such a level that it is possible for the camera to monitor rodents entering into the box 100 at ground level beyond the platform 112. Alternatively, other means for registration of rodent activity may be mounted inside the cavity 105, either together with a camera or without a camera.

If the box 100 is provided with a camera, the box 100 may be used to monitor rodent activity in an area, and if the box 100 is provided with a trap such as an automatic or electric trap or a mechanical trap, it may be used to trap and/or kill rodents in an area monitored by the box, the box 100 may comprise both a camera 122 for monitoring activity and a trap for killing or capturing rodents.

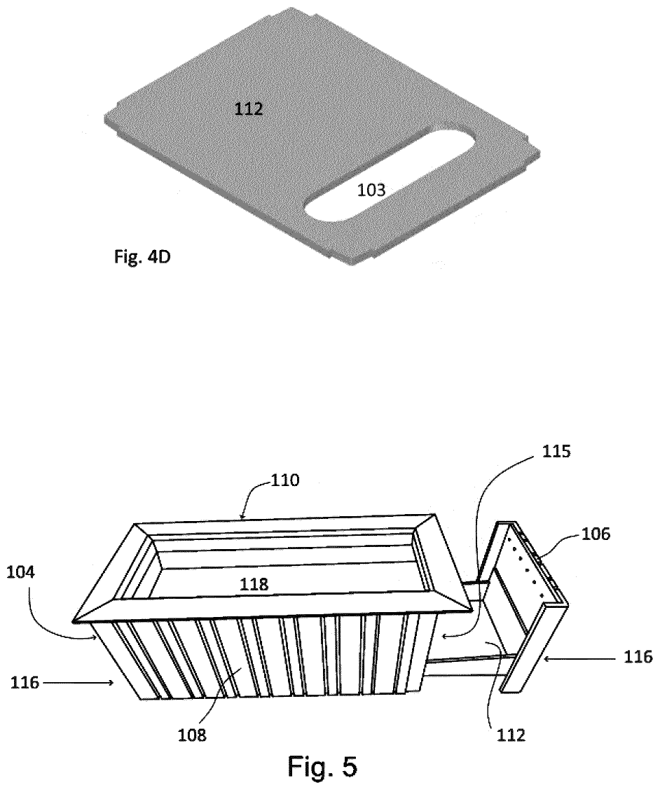

FIG. 4A-4C shows three different views of a second embodiment of a box according to the invention. The second embodiment comprises a closed box 100 having vertical walls. The four side walls 104, 106, 108, 110 and the top cover 118 are prepared from molded polymer. Entrance openings 116 extending in approximately half the length of opposed walls 108, 110 are positioned at ground level. The not shown inner cavity 105 is closed by a hinged top cover 118 which top cover 118 has an open position allowing access to the inner cavity by a user and a closed position preventing access to the inner cavity 105 by users and by-passers. The box 100 also comprises a locking mechanism 119 which prevents pivoting the top cover 118 away from the closed position and into an open position, the shown locking mechanism 119 may be secured by a padlock.

FIG. 4D shows a platform 112 which may be placed at a raised level inside the inner cavity 105 of the box 100 of the second embodiment. The outer perimeter of the platform 112 is fitted to the inner surfaces of the walls of the box 100. Further, the platform 112 comprises an access opening 103 allowing rodents to enter upon the platform 112 from ground level, the access opening 103 is cut out of the plate constituting the platform 112.

FIG. 5 shows a third embodiment of a box 100 according to the invention. The housing of the box 100 according to the third embodiment is rectangular comprising four upright or vertical walls and is provided with a plant box on top. Like the first embodiment, the third embodiment comprises a front wall 108, a rear wall 110 and two side walls 104, 106. The front wall 108, the rear wall 110, and the sidewalls 104, 106 are securely connected together forming a housing. A user access opening 115 is positioned at one end of the housing and appears when the side wall 106 of the housing is pulled away from the stationary walls 108, 104, 110 of the housing.

The third embodiment of the box 100 according to the invention is constructed to be positioned in the public domain and comprises a flower or plant box at an upper level, i.e. above the not disclosed inner cavity. The upper level is open to the public and people passing by may both see and touch what is the placed at this level. Beyond this upper level is a closed inner cavity 105 which in a horizontal plane is limited or defined by the inner surfaces of the four walls of the housing and which upward is limited by top cover which may be constituted by the bottom of the plant box and down ward is limited by the ground level surface. The lower end of the walls of the housing may be positioned directly on the ground level or may be raised up above ground level by legs extending from the lower end of the walls or by wheels position below the walls. At least the lower ends of the two walls 104 and 106 are provided entrance openings 116 at ground level allowing rodents to enter into the housing. A platform 112 is placed inside the inner cavity 105 at a level above ground level and the platform 112 is fixed to the side wall 106. When the side wall 106 is pulled away from the stationary walls 108, 104, 110 of the housing, the platform 112 is also pulled out in the open through the user access opening 115. At this open state, a user may clean a trap positioned on the platform 112 or place food or maintain a camera, etc.

The third embodiment of the box 100 is relatively large, the length of the housing may be around 1.2 m creating an inner cavity 105 of approximately the same length. The total height of the walls of the housing is around 60 cm, and the platform 112 is positioned around 10 cm above ground level, while the complete height of the inner cavity 105 is around 40 cm. An inner cavity of this size will primarily appeal to rats having a head and body length ranging from 15 to 28 cm.

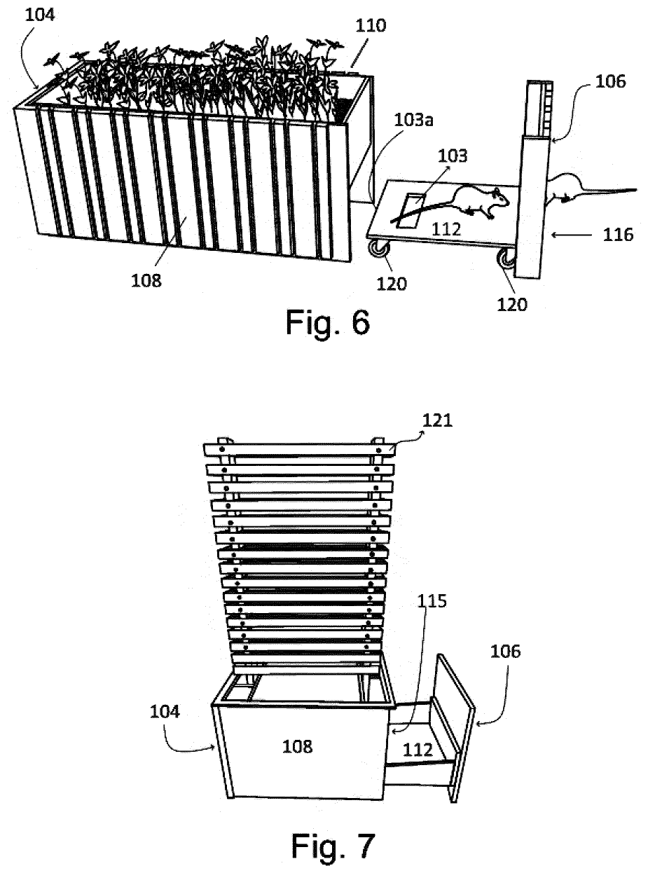

FIG. 6 shows a fourth embodiment of a box 100 according to the invention. The fourth embodiment comprises the same elements as the third embodiment. However, the platform 112 is supported by wheels 120 which makes it easier and smoother to pull the side wall 106 away from the stationary walls 108, 104, 110 of the housing. The platform 112 comprises a rodent access opening 103 positioned near one end of the platform 112 this position of the rodent access opening 103 provides ample space for a rodent to jump onto the platform 112 and explore the room. The platform 112 may be adapted to fit into the inner cavity 105 provided by the inner surfaces of the walls of the housing, however, the platform 112 may also be smaller allowing a rodent to enter the platform 112 not only by the rodent access opening 103 but also by one or more rodent access edges 103a.

FIG. 7 shows a fifth embodiment of a box 100 according to the invention. The housing of the box 100 according to the fifth embodiment is rectangular comprising four upright or vertical walls and is provided with a plant box comprising a trellis 121 extending upward above the housing. Beside the trellis, the fifth embodiment comprises the same elements as the third embodiment of FIG. 5. However, the housing is smaller, approximately half the length of third embodiment, i.e. the inner cavity is around 60-70 cm in length.

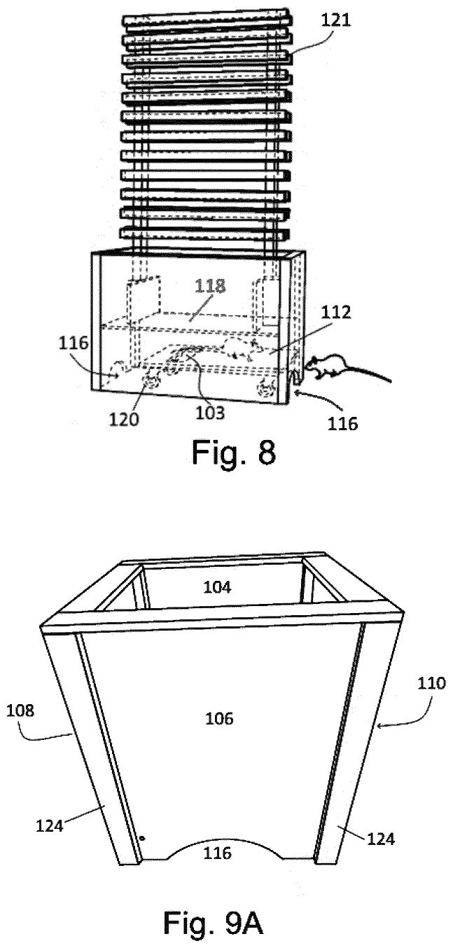

FIG. 8 shows a see-through view of the fifth embodiment which illustrates how the upward cover 118 of the inner cavity is constituting a closed bottom of the upward open plant box.

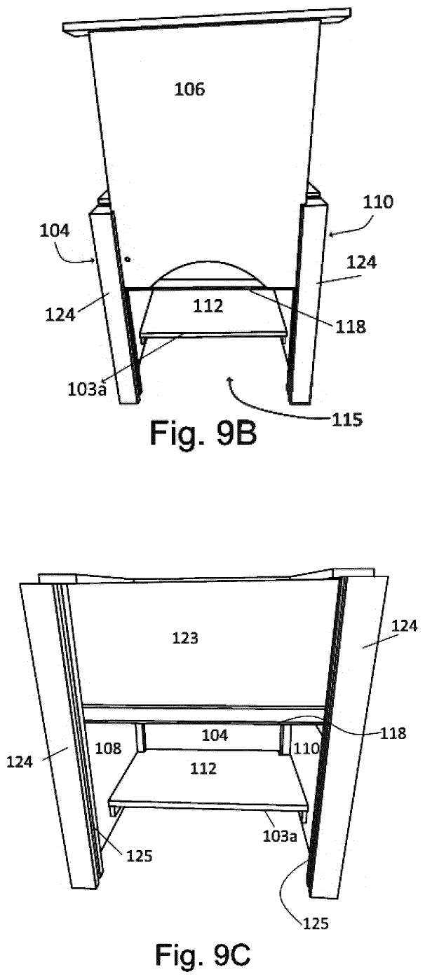

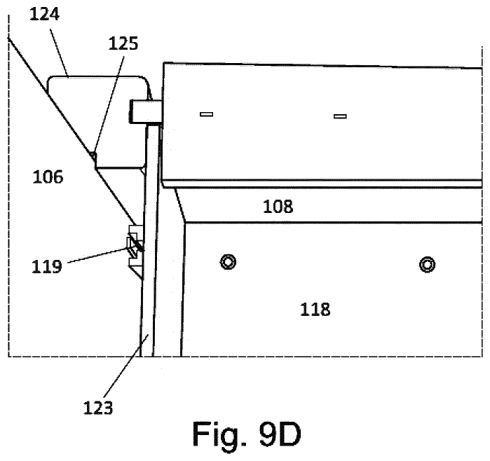

FIG. 9A-9D shows a sixth embodiment of a rodent trap and/or monitoring box 100 according to the invention.

FIG. 9A shows the sixth embodiment in a closed state i.e. a state where the inner cavity 105 is closed as the user access opening 115 is covered by a side wall 106. The side wall 106 comprises an entrance opening 116 which in the closed state is positioned at ground level. The opposite wall 104 may also comprise such an entrance opening 116.

FIG. 9B shows the sixth embodiment in a semi-open state. The side wall 106 constitute a cover for the user access opening 115 which user access opening 115 has been partly revealed in FIG. 9B. The two corner supports 124 to which the side walls 104 and 110 are fixed, comprises guiding rails in which the side wall 106 can slide up and down between a closed and an open position. When the cover constituted by the side wall 106 is positioned in the semi-open state, it is possible to see a stationary platform 112 being mounted on supports fixed to 2-3 walls of the housing.

A top cover 118 defining the upper limit of the inner cavity 105 can be seen just below the partly lifted cover/side wall 106.

FIG. 9C shows the sixth embodiment in a state where the cover/side wall 106 has been completely removed. This view further makes it possible to an end wall 123 of the plant box.

FIG. 9D shows a downward view at the support 124 between the stationary wall 108 and the movable cover/side wall 106. Close to this corner is a locking mechanism 119 positioned. One part of the locking mechanism 119 is fixed to a stationary part e.g. the wall 123 of the plant box while a second part of the locking mechanism is fixed to the movable part i.e. the cover/side wall 106. The locking mechanism 119 may lock the position of the cover/side wall 106 in at least two positions relative to the stationary parts of the box 100. Preferably, the locking mechanism 119 may also lock the cover/side wall 106 in a third position, e.g. the position shown in FIG. 9C, at which position the user access opening 115 allows for a user to clean or maintain traps or cameras positioned on the platform 112 or attached to the walls inside the inner cavity 105.

The box 100 is simple in structure, convenient to install/mount and use, high in sensitivity, environmentally friendly, and provides a high degree of safety, it is e.g. possible to prevent user access to the inner cavity of the box 100 by a padlock or other locking mechanism, a nice appearance, effective for trapping rodents, and has a high market prospect. The box 100 may be inexpensive or luxurious depending on the material chosen for construction, it is simple in design, reliable, and may be able to withstand harsh environments.

| Ref. | |
|---|---|
| No. | Ref. name |
| 100 | Rodent trap box |
| 101 | Carrying means |
| 103 | Rodent access opening |
| 103a | Rodent access edge |
| 104 | Side wall vertically extending substantially vertically |
| 105 | Inner cavity defined by inner surfaces of side walls |
| | of housing, may be open upward |
| 106 | Side wall extending substantially vertically |
| 108 | Front wall extending substantially vertically |
| 110 | Rear wall extending substantially vertically |
| 112 | Platform or downward surface i.e. bottom or ground |
| | level for inner cavity |
| 115 | User access opening |
| 116 | Entrance opening |
| 117 | Rail supporting housing |
| 118 | Upward cover for inner cavity |
| 119 | Locking mechanism |
| 120 | Wheels supporting platform |
| 121 | Trellis |
| 122 | Camera |
| 123 | Plant box wall |
| 124 | Housing supports |
| 125 | Guiding rails for cover |

1. A rodent trap and/or monitoring box used for trapping and/or monitoring rodents, comprising:
housing comprising one or more walls extending upwards to form a cavity, the cavity is limited upward by a cover and is limited at least partly downwards by a surface, either walls or surface comprise an access opening or an access edge allowing a rodent to access the surface from ground level;
trapping device is positioned inside the cavity, and/or a camera is positioned inside or outside of the cavity at a position where it is possible to register rodent activity inside or in and out of the cavity, and/or means for registration such as a sensor are positioned inside or outside of the cavity at a position to register activity inside or in and out of the cavity;
wherein the cavity is sized in a horizontal dimension to allow a rodent to position itself on the downward limiting surface and the cavity is at least the size of a body length of the targeted rodent in at least one horizontal dimension.

2. The rodent trap and/or monitoring box according to claim 1, wherein the surface comprises or is constituted of at least one platform raised above ground level, and an area of the at least one platform is sized for a targeted rodent such as a rat to position itself on the platform.

3. The rodent trap and/or monitoring box according to claim 2, wherein the platform is positioned one or more of at least 2 cm above ground level, at least 5 cm above ground level, at least 7 cm above ground level, and at least 10 cm above ground level, wherein the platform is positioned at a height defined by allowing the targeted rodent within the cavity on the platform.

4. The rodent trap and/or monitoring box according to claim 2, wherein the platform is configured to attract rodents by comprising materials and surface structures appealing to the targeted rodent.

5. The rodent trap and/or monitoring box according to claim 2, wherein the platform is made of a natural material such as wood or a wood product such as plywood.

6. The rodent trap and/or monitoring box according to claim 2, wherein the housing is at least partly or completely without bottom, in such a way that when the housing comprises a platform this allows rodents to pass below a platform on ground surface, and when the housing does not comprise a platform this allows rodents to enter the housing via the ground surface, the housing supported by the upward extending walls or the housing supported by legs extending below the walls or below the platform.

7. The rodent trap and/or monitoring box according to claim 2, wherein the inner cavity at a horizontal dimension comprises one or more of:
a minimum cross-section of at least 15 cm, at least 15×25 cm for a rectangular inner cavity and at least 15 cm in diameter for a round inner cavity, and/or the area of the cross-section is at least 175 cm²,
a minimum cross-section of at least 20 cm, at least 20×25 cm for a rectangular inner cavity and at least 20 cm in diameter for a round inner cavity, and/or the area of the cross-section is at least 314 cm², and
a minimum cross-section of at least 25 cm, at least 25×25 cm for a rectangular inner cavity and at least 25 cm in diameter for a round inner cavity, and/or the area of the cross-section at least 490 cm².

8. The rodent trap and/or monitoring box according to claim 2, wherein the upward cover defining the upper surface of the inner cavity is positioned one or more of: at least 10 cm above ground level or above a platform, at least 15 cm above ground level or above a platform, at least at least 20 cm above ground level or above a platform, and at least at least 25 cm above ground level or above a platform.

9. The rodent trap and/or monitoring box according to claim 2, wherein the box comprises functional features at a top level above the upward cover or as part of the upward cover, where the box is configured to hold and fix one or more plant boxes or containers, or the box is configured with a closed storage compartment, or the box is configured as a garbage bin or an ash tray.

10. The rodent trap and/or monitoring box according to claim 2, wherein the box comprises a side or top user access opening (115) configured to allow opening and closing during use, the cover or one wall or a part of the cover or a part of the wall has an open and a closed position.

11. The rodent trap and/or monitoring box according to claim 10, comprising a user access opening and comprising a cover covering the user access opening when closed, which cover is fixed to the platform in such a way the platform is pulled out of the cavity when the cover is removed, and the platform may comprise contact parts configured to slide horizontally along guiding rails mounted inside the cavity.

12. The rodent trap and/or monitoring box according to claim 10, comprising a user access top opening and a top cover protecting the access top opening when closed, the top cover is connected to the housing by a hinge and the top cover is configured to be opened by pivoting the top cover relative to a stationary part of the housing where the hinge is attached.

13. The rodent trap and/or monitoring box according to claim 2, wherein the housing comprises a plurality of entrances at ground level, which entrances are positioned in such a way relative to each other that the plurality of entrances allows a rodent to see a path or opening through the inner cavity or below the inner cavity at ground level.

14. The rodent trap and/or monitoring box according to claim 2, comprising a trapping device positioned on ground level or on the platform when present, the trapping device comprising a mechanical trap or an automatic or electrical trap, alternatively, a poison or a trace element allowing tracing a rodent outside the box.

15. The rodent trap and/or monitoring box according to claim 2, wherein a distance d between an entrance opening and a trapping device positioned at ground level, or a distance d between at least one access edge of a platform and a trapping device positioned on the platform is at least a body length of a targeted rodent which, based on the rodent to be targeted, is one or more of at least 5 cm, at least 10 cm, at least 15 cm, and at least 20 cm.

16. A method for monitoring rodent activity in a monitored area, method comprising:
I) reviewing of a monitored area, comprising open land and/or buildings, to identify parts or positions where rodent activity likelihood, and to identify problems such as accessible drains or sewers, or openings where rodents may access buildings, or, an owner/user of the monitored area providing positions where to position the boxes;
II) identifying suitable positions within the monitored area for one or more boxes according to the first aspect, based on knowledge obtained during step I), and setting up boxes at the chosen positions; and
III) receiving data from each box set up in the monitored area, data including number of rodents appearances inside the cavity and number of rodents appearances below a platform, and number of rodents killed in traps inside the box.

17. The method according to claim 16, comprising:
IV) estimating a size of rodent population for a period of time, estimating origin or composition of the population, and estimating population increase or decrease; and
V) based on the population estimation of step IV), making recommendations to the owner/user of the monitored area providing measures needed to change conditions for the population.

18. The method according to claim 16, wherein at least a part of data registered in step III) are registered electronically and transmitted to a platform in real time.

19. The method according to claim 17, wherein the population estimation obtained in step V) is used for documentation toward pest control authorities.

20. The method according to claim 16 wherein between 1- and 30 boxes are used to monitor a monitored area.
